(19) United States
(12) Patent Application Publication
(10) Pub. No.: US 2008/0010741 A1
(43) Pub. Date: Jan. 17, 2008

(54) Procedure for Molding of an Artificial Rock or Wood

(76) Inventors: Quy That Ton, Baton Rouge, LA (US); John Kells, Bakersfield, CA (US)

Correspondence Address: Minh N. Nguyen;THOMAS, KAYDEN, HORSTEMEYER & RISLEY, L.L.P., Suite 1750, 100 Galleria Parkway, N.W., Atlanta, GA, 30339-5948, US

(21) Appl. No.: 11/464,212

(22) Filed: Aug. 14, 2006

Related U.S. Application Data
(60) Provisional application No. 60/831,000, filed on Jul. 14, 2006.

(51) Int. Cl. A47K 3/022; A61H 35/00; E03C 1/00

(52) U.S. Cl. 4/622

(57) ABSTRACT

Methods are disclosed for making artificial rocks and wood. In one embodiment, the method is comprised of the following steps: making a mold that has the shape and surface texture of a rock or wood; applying cementitious material within the mold, the cementitious material including acrylic and/or resin-modified cementitious material; applying a hardcoat on the cementitious material; allowing the cementitious material and hardcoat to harden; and removing the mold, the hardened cementitious material and hardcoat having the shape and surface texture of rock or wood.

### CROSS-REFERENCE TO RELATED APPLICATION

This application claims priority to copending U.S. provisional application entitled, “PROCEDURE FOR MOLDING OF AN ARTIFICIAL ROCK OR WOOD,” having Ser. No. 60/831,000, filed on Jul. 14, 2006, which is entirely incorporated herein by reference.

### TECHNICAL FIELD

This disclosure relates to a method of making artificial rocks, rock formations, and wood, and more particularly to a method of making a base of a pedicure spa that resembles a rock or wood.

### BACKGROUND

The pedicure industry is expanding in today's economy. A pedicure spa is located in many pedicure salons. Customers sit at the pedicure spa where technicians can provide pedicure services as well as spa services. Typically, the base of the pedicure spa is made of plastic and does not resemble natural rocks, rock formations, and natural wood. Thus, a heretofore unaddressed need exists in the industry to provide the base of the pedicure spa that is made up of materials having an enhanced degree of authenticity, such as natural rocks, rock formations, and wood.

In addition, artificial rocks, rock formations, and wood are typically made of plastic or cement. Cement is often used to provide the authenticity of a rock or wood. For example, a method of making artificial rock formation is disclosed in U.S. Pat. No. 4,668,451, to Langson. Langson discloses that cement is applied to the inner surface of a mold. When the mold is removed, the cement resembles the natural rock surface. Cement takes hours to harden and this causes delay in manufacturing artificial rocks, rock formations, and wood. Thus, a heretofore unaddressed need exists in the industry to address the aforementioned deficiencies and inadequacies.

### SUMMARY

Methods are disclosed for making artificial rocks and wood. In one embodiment, the method is comprised of the following steps: making a mold that has the shape and surface texture of a rock or wood; applying cementitious material that includes acrylic and/or resin-modified cementitious material within the mold, forming an outer shell; supporting such outer shell with a hardcoat such as urethane, polyurea, fiberglass, or glass fiber reinforced cement (GFRC); removing the mold; hardening the cementitious material and hardcoat; and painting the exterior of the cementitious material. The painted hardened cementitious material that is reinforced with the hardcoat adopts the shape and surface texture of the mold and resembles the rock or wood.

A pedicure spa is disclosed herein. In one embodiment, the pedicure spa is comprised of a chair, a basin, and a base. Such base is made of cementitious material that includes acrylic and/or resin-modified cementitious material and is reinforced with a hardcoat. The basin and chair are attached to a top portion of the base.

Other apparatuses, methods, features, and advantages of the present disclosure will be or become apparent to one with skill in the art upon examination of the following drawings and detailed description. It is intended that all such additional apparatuses, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 depicts an embodiment of a base of a pedicure spa that resembles a rock formation.

FIG. 2 depicts a cross-sectional view illustrating layers of materials used during the procedure of making an artificial rock, such as that shown in FIG. 1.

FIG. 3 is a flow diagram that illustrates operation of an embodiment of making the artificial rock.

### DETAILED DESCRIPTION

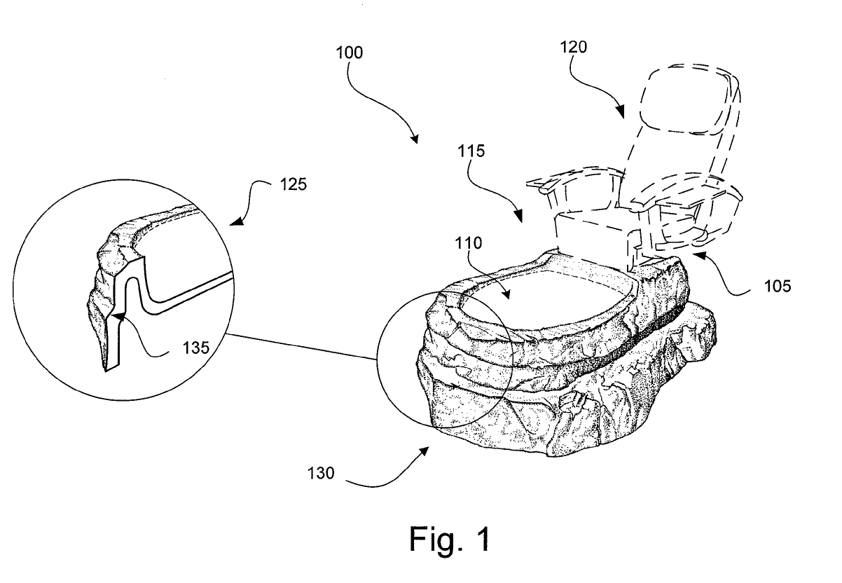

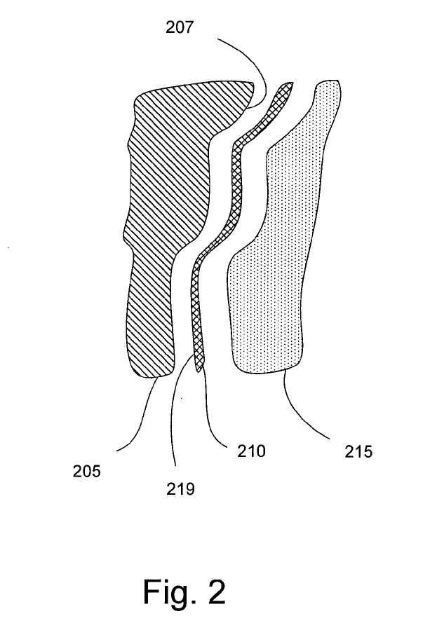

FIG. 1 depicts an embodiment of a base of a pedicure spa that resembles a rock formation. It should be noted that the base can also be made to resemble wood. The base 100 generally includes a seating portion 105. A chair 120 is generally attached on the seating portion 105. A basin 110 is generally disposed in adjacent to the seating portion 105, where water is filled and a person's feet can be submersed in. A foot rest (not shown) can be place adjacent to the basin 110 opposite from seating portion 105. The seating portion 105, basin 110, and the foot rest are generally place on top 115 of the basin 110. The base 100 of the pedicure spa, from a top view, can have the shape of, such as, but not limited to, a rectangle, circle, ellipse, hexagon, octagon, etc. A cross-sectional view 125 of a front portion 130 of the base 100 shows the outer shape and the surface texture 135 of the artificial rock, which are described later in relation to FIG. 2.

FIG. 2 depicts a cross-sectional view illustrating layers of materials used during the procedure of making an artificial rock, such as that shown in FIG. 1. The artificial rock is generally made using a molding process that shapes pliable raw material using a frame or model called a mold 205. The mold 205 is a hollowed-out block that is filled with a liquid, such as but not limited to, plastic, glass or metal. The liquid hardens or sets inside the mold 205, adopting its shape. In this instance, the interior portion 207 of the mold 205 resembles the outer shape and the surface texture 135, such as that shown in the cross-sectional view 125 of a front portion of the base 100 in FIG. 1. Referring back to FIG. 2, after the mold 205 is made, cementitious material is applied within the mold 205, forming an outer shell. The cementitious material 210 includes acrylic and/or resin-modified cementitious material. After the outer shell 210 hardens, a hardcoat, such as urethane, polyurea, fiberglass, or GFRC 215, is applied on the outer shell 210. Once the outer shell and hardcoat within the mold harden, the mold 205 is pulled off; the result is a base of a pedicure spa that has the appearance of a rock or wood.

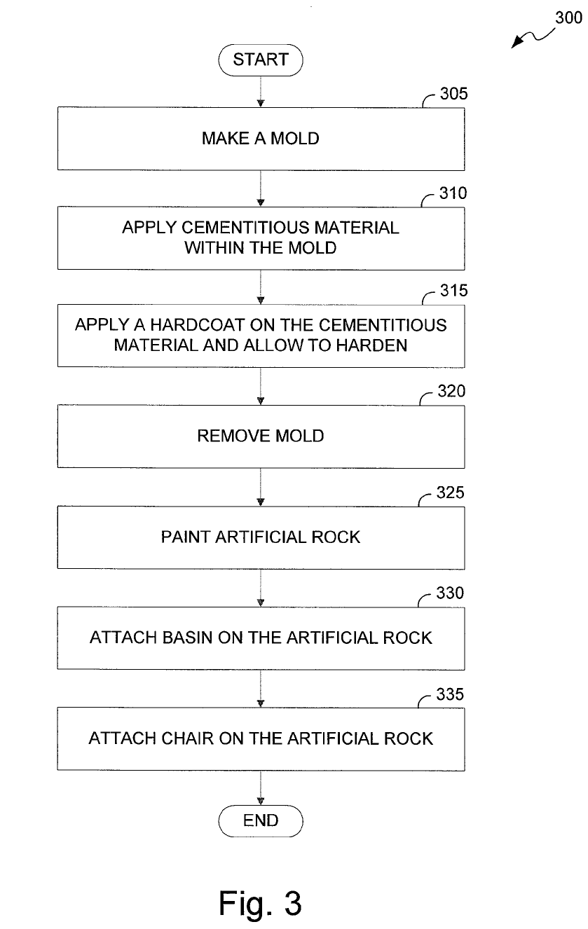

The cementitious material further includes, but is not limited to, cement, glass fiber reinforced cement (GFRC), and glass fiber reinforcement. The GFRC is a cement-based composite containing glass fibers for reinforcement. GFRC is substantially lower in weight than plain concrete, with higher flexural and compressive strengths. As mentioned above, acrylic and/or resin-modified cementitious material can be used in conjunction with the hardcoat to form the base resembling rock and wood. The hardcoat includes, but is not limited to, polyurea/polyurethane hybrid. The artificial rock or wood made of acrylic and/or resin-modified cementitious material reinforced with the hardcoat hardens more quickly than artificial rock or wood made only of cement; thus, more artificial rocks can be manufactured in a shorter period of time. FIG. 3 is a flow diagram that illustrates operation of an embodiment of making the artificial rock. Beginning with block 305, the operation 300 is comprised of making a mold of a rock, rock formation, or wood. There are various ways of making a mold. In one embodiment, the method begins with locating a natural rock or wood that is to be used for its shape and surface texture. The rock includes, but is not limited to, a rock, boulder, combination of rocks, and cliffs. The wood includes, but is not limited to, a tree and a combination of the trunk and root of the tree. The surface of the rock to be molded is cleaned, and flanges are installed if needed. The rock or wood is allowed to dry and then is applied with a few coats of silicone urethane latex using a paint brush or airless sprayer with drying time between each coat. It should be noted that other materials can be used in place of latex, such as, but not limited to, silicone, urethane, or other similar materials.

The latex is applied with a few layers of cheesecloth with drying time between each layer. It should be noted that other materials can be used in place of cheesecloth, such as burlap and nylon mesh. The dried cheesecloth is then applied with a few more coats of latex to seal against moisture. The latex is then dried, and flanges are placed on the latex if needed. The dried latex is coated with a bond release, and the bond release is coated with fiberglass or polyurea/polyurethane. The fiberglass and latex are peeled off, forming the mold.

In block 310, the mold receives cementitious material that includes the acrylic and/or resin-modified cementitious material, which is generally sprayed within the molds. The cementitious material is applied in the mold to form an outer shell shell. In block 315, once the cementitious material within the mold hardens, spray a hardcoat such as urethane, polyurea, fiberglass, or GFRC. In block 320, when the hardcoat hardens, pull off the mold. In block 325, the exposed layer of the hardened outer shell is painted to resemble natural rock. In blocks 330 and 335, a basin and chair are attached to the base of the pedicure spa. Plumbing and electrical parts can also be attached to the base.

It should be emphasized that the above-described embodiments are merely possible examples of implementations, merely set forth for a clear understanding of the principles of the disclosure. Many variations and modifications may be made to the above-described embodiments without departing substantially from the spirit and principles of the disclosure. All such modifications and variations are intended to be included herein within the scope of this disclosure and the present disclosure and protected by the following claims.

Therefore, having thus described the invention, at least the following is claimed:

1. A method for making an artificial rock or wood, the method comprising the steps of:
making a mold that has the shape and surface texture of a rock or wood;
applying cementitious material within the mold, the cementitious material including acrylic and/or resin-modified cementitious material;
applying a hardcoat on the cementitious material;
allowing the cementitious material and hardcoat to harden; and
removing the mold, the hardened cementitious material and hardcoat having the shape and surface texture of rock or wood.

2. The method as defined in claim 1, wherein applying cementitious material comprises applying fiberglass in conjunction with the cementitious material.

3. The method as defined in claim 1, wherein the hardcoat includes one of the following: polyurea/polyurethane hybrid, urethane, polyurea, fiberglass, and GFRC.

4. The method as defined in claim 1, wherein the cementitious material further includes one of cement, glass fiber reinforced cement (GFRC), and glass fiber reinforcement.

5. The method as defined in claim 1, further comprising applying the cementitious material within the mold, forming an outer shell, the cementitious material being applied and having hardened before applying the hardcoat.

6. The method as defined in claim 1, wherein the mold includes a latex mold.

7. The method as defined in claim 1, further comprising attaching a basin on top of the artificial rock or wood.

8. The method as defined in claim 1, further comprising attaching a chair on top of the artificial rock or wood.

9. The method as defined in claim 1, further comprising painting the cementitious material to resemble the rock or wood.

10. The method as defined in claim 5, further comprising painting the outer shell to resemble the rock or wood.

11. A pedicure spa comprising:
a chair;
a basin; and
a base that is made of cementitious material and hardcoat, the cementitious material including acrylic and/or resin-modified cementitious material, the basin and chair being attached to a top portion of the base.

12. The pedicure spa as defined in claim 11, wherein the base resembles one of a rock or wood.

13. The pedicure spa as defined in claim 11, wherein the cementitious material includes one of cement, glass fiber reinforced cement (GFRC), and glass fiber reinforcement.

14. The pedicure spa as defined in claim 11, wherein the base is made from the following steps:
making a mold that has the shape and surface texture of a rock or wood;
applying cementitious material within the mold the cementitious material including acrylic and/or resin-modified cementitious material;
applying a hardcoat on the cementitious material;
allowing the cementitious material and hardcoat to harden; and
removing the mold, the hardened cementitious material and hardcoat having the shape and surface texture of rock or wood.

15. The pedicure spa as defined in claim 14, wherein the step of applying the cementitious material comprises applying fiberglass in conjunction with the cementitious material.

16. The pedicure spa as defined in claim 15, wherein the hardcoat includes one of the following: polyurea/polyurethane hybrid, urethane, polyurea, fiberglass, and GFRC.

17. The pedicure spa as defined in claim 14, wherein the steps of making the base further comprises applying the cementitious material within the mold, forming an outer shell, the cementitious material being applied and having hardened before applying the hardcoat.

18. The pedicure spa as defined in claim 14, wherein the mold includes a latex mold.

19. The pedicure spa as defined in claim 14, wherein the steps of making the base further comprises painting the cementitious material to resemble the rock or wood.

20. The pedicure spa as defined in claim 17, wherein the steps of making the base further comprises further comprising painting the outer shell to resemble the rock or wood.
